(19) United States
(12) Patent Application Publication
(10) Pub. No.: US 2024/0195560 A1
(43) Pub. Date: Jun. 13, 2024

(54) METHODS OF ENHANCING TRIGGERING FLEXIBILITY OF APERIODIC SOUNDING REFERENCE SIGNAL

(71) Applicant: NTT DOCOMO, INC., Tokyo (JP)

(72) Inventors: Nadisanka Rupasinghe, Sunnyvale, CA (US); Yuki Matsumura, Tokyo (JP)

(73) Assignee: NTT DOCOMO, INC., Tokyo (JP)

(21) Appl. No.: 18/550,558

(22) PCT Filed: Mar. 15, 2022
(86) PCT No.: PCT/US2022/020343

§ 371 Date: Sep. 14, 2023

Related U.S. Application Data
(60) Provisional application No. 63/161,633, filed on Mar. 16, 2021.

(51) Int. Cl. H04L 5/00

(52) U.S. Cl. CPC H04L 5/0048; H04L 5/0078; H04L 5/0091

(57) ABSTRACT

A wireless communication method for a terminal includes: receiving, via downlink control information (DCI) or higher layer signaling, configuration information including a parameter, configuring Aperiodic Sounding Reference Signal (A-SRS) transmission based on the parameter; and reporting, based on a usage setting, capability information including a minimum timing requirement between A-SRS triggering Physical Downlink Control Channel (PDCCH) and SRS resources in a resource set.

### BACKGROUND

### Technical Field

One or more embodiments disclosed herein relate to mechanism(s) to how aperiodic Sounding Reference Signal (SRS) triggering can be enhanced by introducing additional flexibility.

### Description of Related Art

In 5G new radio (NR) technologies, new requirements are being identified for further enhancing SRS transmission. New items in Rel. 17 relate to, for example, NR Multiple-Input-Multiple-Output (MIMO).

In the new studies being conducted, enhancement of the SRS is targeted for both Frequency Range (FR) 1 and FR2. In particular, study is under way to identify and specify enhancements on aperiodic SRS triggering to facilitate more flexible triggering and/or Downlink Control Information (DCI) overhead/usage reduction.

Additionally, study is under way to specify SRS switching for up to 8 antennas (e.g., xTyR, x={1,2,4} and y={6,8}). Further, studies are evaluating and, if needed, specifying the following mechanism(s) to enhance SRS capacity and/or coverage including SRS time bundling, increased SRS repetition, and/or partial sounding across frequency.

### CITATION LIST

### Non-Patent References

[Non-Patent Reference 1] 3GPP RP 193133, “New WID: Further enhancements on MIMO for NR”, December, 2019.
[Non-Patent Reference 2] 3GPP RAN1 #103-e, ‘Chairman's Notes’, November, 2020.
[Non-Patent Reference 3] 3GPP RAN1 #104-e, ‘Chairman's Notes’, February, 2021.
[Non-Patent Reference 4] 3GPP TS 38.214, “NR; Physical procedure for data (Release 16).”
[Non-Patent Reference 5] 3GPP TS 38.212, “NR; Multiplexing and channel coding (Release 16).”
[Non-Patent Reference 6] 3GPP TS 38.331, “NR; Radio Resource Control; Protocol specification (Release 15).”

### SUMMARY

In general, in one aspect, embodiments disclosed herein relate to a wireless communication method for a terminal that includes receiving, via downlink control information (DCI) or higher layer signaling, configuration information including a parameter; configuring Aperiodic Sounding Reference Signal (A-SRS) transmission based on the parameter; and reporting, based on a usage setting, capability information including a minimum timing requirement between A-SRS triggering Physical Downlink Control Channel (PDCCH) and SRS resources in a resource set.

In general, in one aspect, embodiments disclosed herein relate to a terminal that includes a receiver that receives, via downlink control information (DCI) or higher layer signaling, configuration information including a parameter; and a processor that configures Aperiodic Sounding Reference Signal (A-SRS) transmission based on the parameter; and reports, based on a usage setting, capability information including a minimum timing requirement between A-SRS triggering Physical Downlink Control Channel (PDCCH) and SRS resources in a resource set.

In general, in one aspect, embodiments disclosed herein relate to a terminal that includes a first receiver that receives via downlink control information (DCI) or higher layer signaling, configuration information including a parameter; a processor that configures Aperiodic Sounding Reference Signal (A-SRS) transmission based on the parameter; and reports, based on a usage setting, capability information including a minimum timing requirement between A-SRS triggering Physical Downlink Control Channel (PDCCH) and SRS resources in a resource set; and a base station comprising: a transmitter that transmits via DCI or higher layer signaling, configuration information including the parameter; and a second receiver that receives the capability information.

Other embodiments and advantages of the present invention will be recognized from the description and figures.

### BRIEF DESCRIPTION OF THE DRAWINGS

FIG. 1 is a diagram showing a schematic configuration of a wireless communications system according to embodiments.

FIG. 2 is a diagram showing a schematic configuration of a base station (BS) according to one or more embodiments.

FIG. 3 is a schematic configuration of a user equipment (UE) according to one or more embodiments.

FIG. 4 shows an overview of potential enhancements to aperiodic SRS triggering.

FIG. 5 shows an example table of PUSCH preparation time.

FIG. 6 shows an example of DCI fields.

FIG. 7 shows an example of DCI fields.

FIG. 8 shows an example of a higher layer parameter.

FIG. 9 shows an example table of an extended number of DCI codepoints for A-SRS trigger states.

FIG. 10 shows an example of higher layer parameters.

FIG. 11 shows an example of higher layer parameters.

FIG. 12 shows an example table of an extended number of DCI codepoints for A-SRS trigger states.

### DETAILED DESCRIPTION

Embodiments of the present invention will be described in detail below with reference to the drawings. Like elements in the various figures are denoted by like reference numerals for consistency.

In the following description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

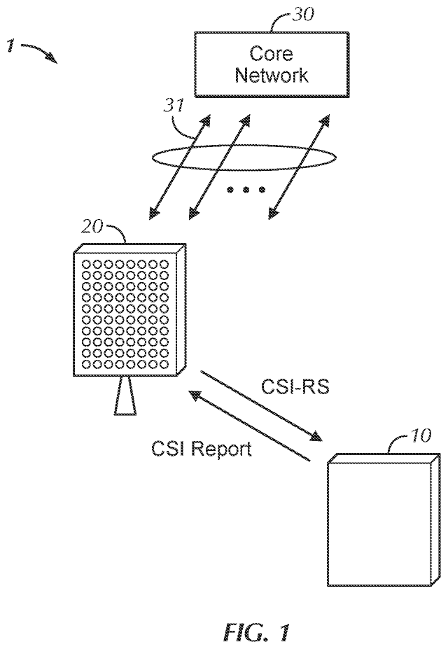

FIG. 1 describes a wireless communications system 1 according to one or more embodiments of the present invention. The wireless communication system 1 includes a user equipment (UE) 10, a base station (BS) 20, and a core network 30. The wireless communication system 1 may be a NR system. The wireless communication system 1 is not limited to the specific configurations described herein and may be any type of wireless communication system such as an LTE/LTE-Advanced (LTE-A) system.

The BS 20 may communicate uplink (UL) and downlink (DL) signals with the UE 10 in a cell of the BS 20. The DL and UL signals may include control information and user data. The BS 20 may communicate DL and UL signals with the core network 30 through backhaul links 31. The BS 20 may be gNodeB (gNB). The BS 20 may be referred to as a network (NW) 20.

The BS 20 includes antennas, a communication interface to communicate with an adjacent BS 20 (for example, X2 interface), a communication interface to communicate with the core network 30 (for example, S1 interface), and a CPU (Central Processing Unit) such as a processor or a circuit to process transmitted and received signals with the UE 10. Operations of the BS 20 may be implemented by the processor processing or executing data and programs stored in a memory. However, the BS 20 is not limited to the hardware configuration set forth above and may be realized by other appropriate hardware configurations as understood by those of ordinary skill in the art. Numerous BSs 20 may be disposed so as to cover a broader service area of the wireless communication system 1.

The UE 10 may communicate DL and UL signals that include control information and user data with the BS 20 using Multi Input Multi Output (MIMO) technology. The UE 10 may be a mobile station, a smartphone, a cellular phone, a tablet, a mobile router, or information processing apparatus having a radio communication function such as a wearable device. The wireless communication system 1 may include one or more UEs 10.

The UE 10 includes a CPU such as a processor, a RAM (Random Access Memory), a flash memory, and a radio communication device to transmit/receive radio signals to/from the BS 20 and the UE 10. For example, operations of the UE 10 described below may be implemented by the CPU processing or executing data and programs stored in a memory. However, the UE 10 is not limited to the hardware configuration set forth above and may be configured with, e.g., a circuit to achieve the processing described below.

As shown in FIG. 1, the BS 20 may transmit a CSI-Reference Signal (CSI-RS) to the UE 10. In response, the UE 10 may transmit a CSI report to the BS 20. Similarly, the UE 10 may transmit SRS to the BS 20.

### (Configuration of BS)

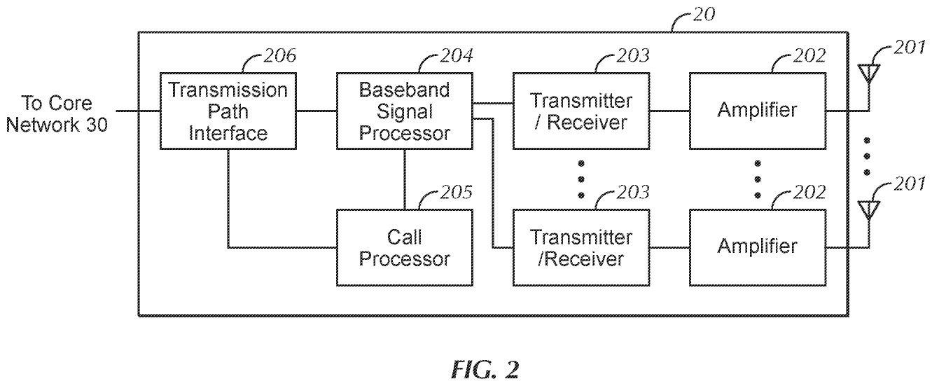

The BS 20 according to embodiments of the present invention will be described below with reference to FIG. 2. FIG. 2 is a diagram illustrating a schematic configuration of the BS 20 according to embodiments of the present invention. The BS 20 may include a plurality of antennas (antenna element group) 201, amplifier 202, transceiver (transmitter/receiver) 203, a baseband signal processor 204, a call processor 205 and a transmission path interface 206.

User data that is transmitted on the DL from the BS 20 to the UE 20 is input from the core network, through the transmission path interface 206, into the baseband signal processor 204.

In the baseband signal processor 204, signals are subjected to Packet Data Convergence Protocol (PDCP) layer processing, Radio Link Control (RLC) layer transmission processing such as division and coupling of user data and RLC retransmission control transmission processing, Medium Access Control (MAC) retransmission control, including, for example, HARQ transmission processing, scheduling, transport format selection, channel coding, inverse fast Fourier transform (IFFT) processing, and precoding processing. Then, the resultant signals are transferred to each transceiver 203. As for signals of the DL control channel, transmission processing is performed, including channel coding and inverse fast Fourier transform, and the resultant signals are transmitted to each transceiver 203.

The baseband signal processor 204 notifies each UE 10 of control information (system information) for communication in the cell by higher layer signaling (e.g., Radio Resource Control (RRC) signaling and broadcast channel). Information for communication in the cell includes, for example, UL or DL system bandwidth.

In each transceiver 203, baseband signals that are precoded per antenna and output from the baseband signal processor 204 are subjected to frequency conversion processing into a radio frequency band. The amplifier 202 amplifies the radio frequency signals having been subjected to frequency conversion, and the resultant signals are transmitted from the antennas 201.

As for data to be transmitted on the UL from the UE 10 to the BS 20, radio frequency signals are received in each antennas 201, amplified in the amplifier 202, subjected to frequency conversion and converted into baseband signals in the transceiver 203, and are input to the baseband signal processor 204.

The baseband signal processor 204 performs FFT processing, IDFT processing, error correction decoding, MAC retransmission control reception processing, and RLC layer and PDCP layer reception processing on the user data included in the received baseband signals. Then, the resultant signals are transferred to the core network through the transmission path interface 206. The call processor 205 performs call processing such as setting up and releasing a communication channel, manages the state of the BS 20, and manages the radio resources.

### (Configuration of UE)

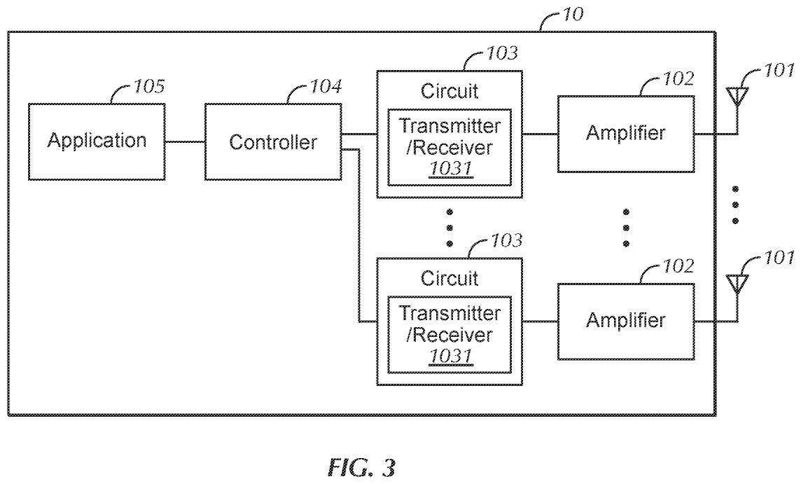

The UE 10 according to embodiments of the present invention will be described below with reference to FIG. 3. FIG. 3 is a schematic configuration of the UE 10 according to embodiments of the present invention. The UE 10 has a plurality of UE antenna S101, amplifiers 102, the circuit 103 comprising transceiver (transmitter/receiver) 1031, the controller 104, and an application 105.

As for DL, radio frequency signals received in the UE antenna S101 are amplified in the respective amplifiers 102, and subjected to frequency conversion into baseband signals in the transceiver 1031. These baseband signals are subjected to reception processing such as FFT processing, error correction decoding and retransmission control and so on, in the controller 104. The DL user data is transferred to the application 105. The application 105 performs processing related to higher layers above the physical layer and the MAC layer. In the downlink data, broadcast information is also transferred to the application 105.

On the other hand, UL user data is input from the application 105 to the controller 104. In the controller 104, retransmission control (Hybrid ARQ) transmission processing, channel coding, precoding, DFT processing, IFFT processing and so on are performed, and the resultant signals are transferred to each transceiver 1031. In the transceiver 1031, the baseband signals output from the controller 104 are converted into a radio frequency band. After that, the frequency-converted radio frequency signals are amplified in the amplifier 102, and then, transmitted from the antenna 101.

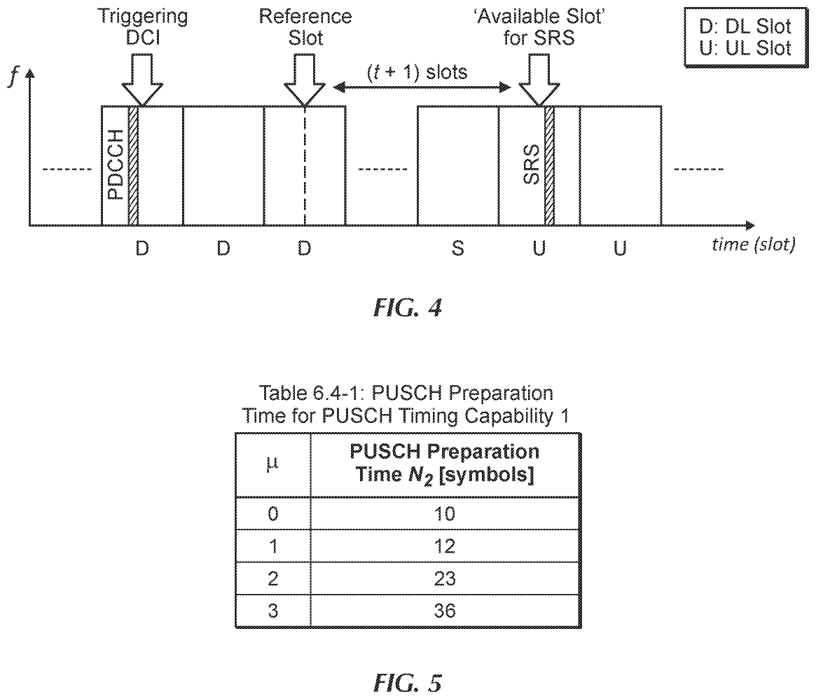

One or more embodiments of the present invention with reference to FIG. 4 relate to enhancements for aperiodic SRS triggering. In particular, as noted in [2], possible considerations include the following. A given aperiodic SRS resource set may be transmitted in the (t+1)-th available slot counting from a reference slot, where t is indicated from DCI or RRC (if only one value of t is configured in RRC), and the candidate values of t at least include 0. Further, one or more of following options for the reference slot may be considered. As a one option, the reference slot is the slot with the triggering DCI. As another option, the reference slot is the slot indicated by the legacy triggering offset.

Under consideration as well is the definition of “available slot” considering UE processing complexity and a timeline to determine an available slot as well as potential co-existence with collision handling. Based on only RRC configuration, “available slot” is the slot satisfying: there are UL or flexible symbol(s) for the time-domain location(s) for all the SRS resources in the resource set and it satisfies the minimum timing requirement between triggering PDCCH and all the SRS resources in the resource set.

Also under consideration is explicit or implicit indication of t and whether updating candidate triggering offsets in MAC CE may be beneficial.

As discussed above, studies are under way with regard to the enhancement of SRS. In one or more embodiments described herein UE capability on the minimum timing requirement is considered. Initially, an ‘Available Slot’ may be considered as a slot satisfying a condition that there are UL or flexible symbol(s) for the time-domain location(s) for all the SRS resources in the resource set. It is also considered as a slot that satisfies a condition of a UE capability on the minimum timing requirement between triggering PDCCH and all the SRS resources in the resource set.

In one or more embodiments, as part of capability reporting, a UE reports the minimum timing requirement between A-SRS triggering PDCCH and all the SRS resources in the resource set. Subsequently, the reported timing requirement can be considered as follows to determine the minimal time interval between the last symbol of the PDCCH triggering the aperiodic SRS transmission and the first symbol of SRS resource.

Consider that the UE as part of its capability reports the minimum timing requirement as, N₃ symbols. In this case, this minimum timing requirement can then be considered for identifying the minimal time interval as follows.

Turning to an instance where SRS resource set usage is set to ‘codebook’ or ‘antenna switching.’

As a first option for SRS in a resource set with usage set to ‘codebook’ or ‘antennaSwitching,’ the minimal time interval between the last symbol of the PDCCH triggering the aperiodic SRS transmission and the first symbol of the SRS resource is N₃ symbols and an additional time duration T_{switch}.

As a second option for SRS in a resource set with usage set to ‘codebook’ or ‘antennaSwitching,’ the minimal time interval between the last symbol of the PDCCH triggering the aperiodic SRS transmission and the first symbol of the SRS resource is N₂+N₃ symbols and an additional time duration T_{switch}.

As a third option for SRS in a resource set with usage set to ‘codebook’ or ‘antennaSwitching,’ the minimal time interval between the last symbol of the PDCCH triggering the aperiodic SRS transmission and the first symbol of the SRS resource is Max{N₂, N₃} symbols and an additional time duration T_{switch}.

Turning to an instance where usage is set to ‘non-codebook’ or ‘Beam Management.’

As a first option for SRS in a resource set with usage set to ‘non-codebook’ or ‘Beam Management,’ the minimal time interval between the last symbol of the PDCCH triggering the aperiodic SRS transmission and the first symbol of the SRS resource is N₃+14 symbols and an additional time duration T_{switch}.

As a second option for SRS in a resource set with usage set to ‘non-codebook’ or ‘Beam Management,’ the minimal time interval between the last symbol of the PDCCH triggering the aperiodic SRS transmission and the first symbol of SRS resource is N₂+N₃+14 symbols and an additional time duration T_{switch}.

As a third option for SRS in a resource set with usage set to ‘non-codebook’ or ‘Beam Management,’ the minimal time interval between the last symbol of the PDCCH triggering the aperiodic SRS transmission and the first symbol of the SRS resource is Max{N₂, N₃}+14 symbols and an additional time duration T_{switch}.

In one or more embodiments, irrespective of the SRS ‘usage,’ the minimal time requirement is defined, for example, as Max{existing minimal time for a usage, N₃}. In this scenario, for ‘codebook’ and ‘antennaSwitching’, ‘existing minimal time for usage’ may be defined as N₂. For ‘non-codebook’ and ‘BeamManagement’, ‘existing minimal time for usage’ may be defined as N₂+14.

Further, one or more value(s) of N₂ can be configured as follows.

In a first option, the value of N₂ can be pre-defined in the specification(s). An example from [4], pre-defining N₂ in the specification is shown in FIG. 5.

As a second option, one or more value(s) of N₂ are reported by the UE as part of the UE capability.

It is noted that the minimum timing requirement can be, ‘the last symbol of the PDCCH triggering the aperiodic SRS transmission and the first symbol of SRS resource.’ Further note that, the SRS resource may be the first one to transmit in the triggered SRS resource set.

Additionally, if the UE does not report the minimum timing requirement between A-SRS triggering PDCCH and all the SRS resources in the resource set, the minimum timing requirement may be pre-defined in the specification(s). For example, minimum timing between triggering PDCCH and all the SRS resources in the resource set can be defined as follows.

For SRS in a resource set with usage set to ‘codebook’ or ‘antennaSwitching,’ the minimal time interval between the last symbol of the PDCCH triggering the aperiodic SRS transmission and the first symbol of the SRS resource is N₂ symbols and an additional time duration T_{switch}.

For SRS in a resource set with usage set to ‘non-codebook’ or ‘Beam Management,’ the minimal time interval between the last symbol of the PDCCH triggering the aperiodic SRS transmission and the first symbol of the SRS resource is N₂+14 symbols and an additional time duration T_{switch}.

In one or more embodiments, the value of N₂ can be pre-defined in the specification(s) as shown in FIG. 5.

In one or more embodiments for DCI/PDCCH detection, the UE may try a blind detection (BD) of the DCI format. At an initial step, the UE may assume one possible DCI size of a possible DCI format and assume a possible aggregation level of PDCCH. Further, the UE demodulates the PDCCH and attempts a CRC check. Here, CRC is scrambled by some Radio Network Temporary Identifier (RNTI) (e.g., C-RNTI, etc.).

If the CRC check is passed, the UE identifies that the DCI is correctly received. If not, the UE returns to the initial step and another possible DCI size and aggregation level are assumed and another demodulation attempt is made followed by another CRC check.

Thus, if the number of possible (i.e., different) DCI sizes is increased, number of blind detection (BD) of PDCCH increases as well, which may have a large impact on UE complexity. As a result, in one or more embodiments, it may be important to keep the same number of BD as Rel. 15/16 for the purposes of, for example, complexity.

One or more embodiments relate to the indicate of a parameter t using DCI formats 0_1/0_2. For example, a list of t values may be configured in RRC for each SRS resource set. Afterwards, using DCI, one value out of those in the list is selected [3].

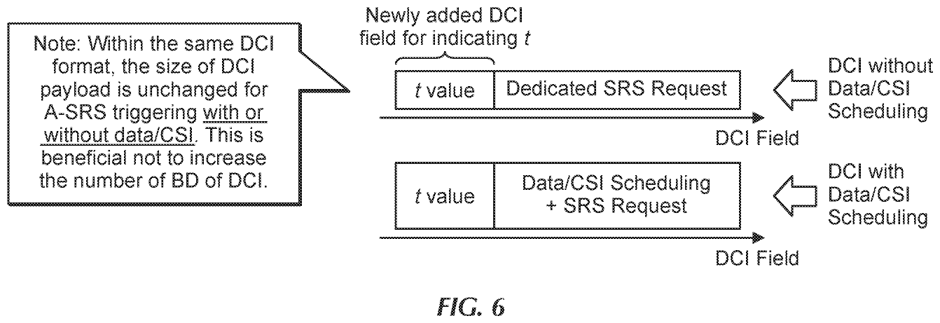

As a first option with reference to FIG. 6, a new configurable DCI field can be added to indicate a t value. In particular, FIG. 6 shows an example of the newly added DCI field for indicating t. It is noted that within the same DCI format, the size of DCI payload is unchanged for A-SRS triggering with or without data/CSI. This is beneficial not to increase the number of BD of DCI. Note also that, the new DCI field may exist only when RRC configures it.

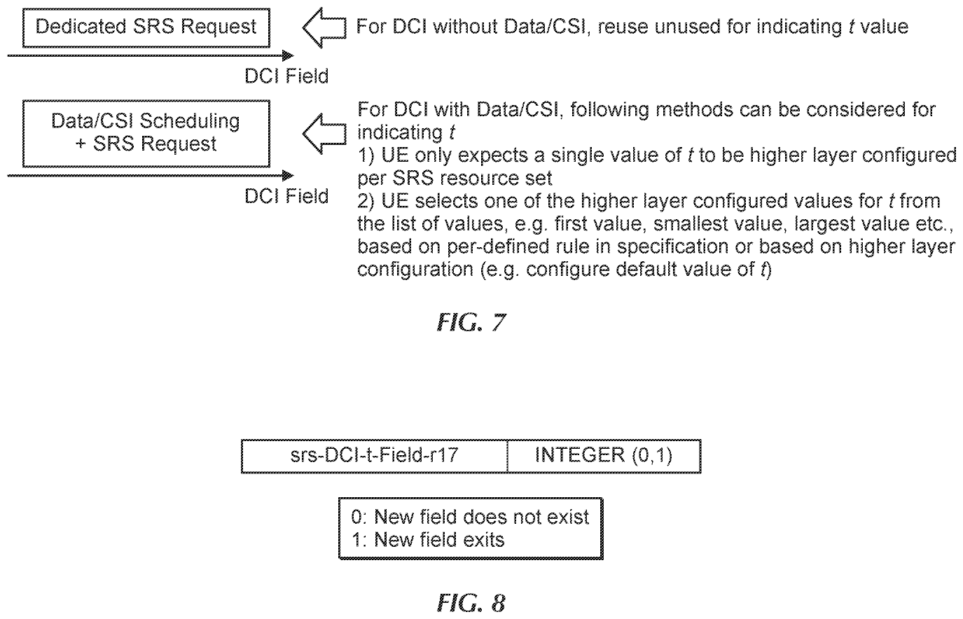

As a second option with reference to FIG. 7, the t value is indicated without adding a new DCI field. In that case, DCI with and without data/CSI scheduling can indicate the t value in different ways. In the case of DCI without data/CSI, unused fields may be reused for indicating a t value. In the case of data/CSI being and the SRS request, the following methods can be considered for indicting t.
1) The UE may only expect a single value of t to be higher layer configured per SRS resource set; or
2) The UE may select one of the higher layer configured values for t from the list of values (e.g., first value, smallest value, largest value etc.) based on one or more pre-defined rules in the specification(s) or based on higher layer configuration (e.g., configure a default value of t).

As mentioned above, in the case of DCI without data/CSI unused fields may be reused. For example, unused DCI fields in DCI without data/CSI may be “DCI fields used for PUSCH scheduling and/or CSI request.” In particular, one or more of the unused DCI fields in the DCI formats 0_1/0_2, without scheduling data/CSI, can be considered for indicating t value as per a second option. One or more examples of some potentially unused DCI fields that can be considered for indicating t can be given as follows:
Bandwidth part indicator
Frequency domain resource assignment
Time domain resource assignment
TPC command for scheduled PUSCH
Precoding information and number of layers
Antenna ports
CSI request

Returning to the first option, it is noted that the new DCI field may only exist when RRC configures it. For example, consider a new RRC parameter, srs-DCI-t-Field-r17, as shown in FIG. 8, which configures the availability of new DCI field for indicating t value. In this example, if srs-DCI-t-Field-r17 is set to 0, the methods discussed under the second option can be considered for indicating t value. If srs-DCI-t-Field-r17 is set to 1, methods discussed under the first option can be considered for indicating t value.

Furthermore, it is noted that if the abovementioned higher layer parameter is configured (i.e., according to the first option) the new DCI field can dynamically indicate the value of t for both cases of DCI for A-SRS triggering with and without data/CSI. Alternatively (i.e., according to the second option), the existing DCI field, which is not used for data scheduling and/or CSI request, can dynamically indicate the value of t for a case of DCI for A-SRS triggering without data/CSI; and the value of t is semi-statically configured for case of DCI for A-SRS triggering with data/CSI.

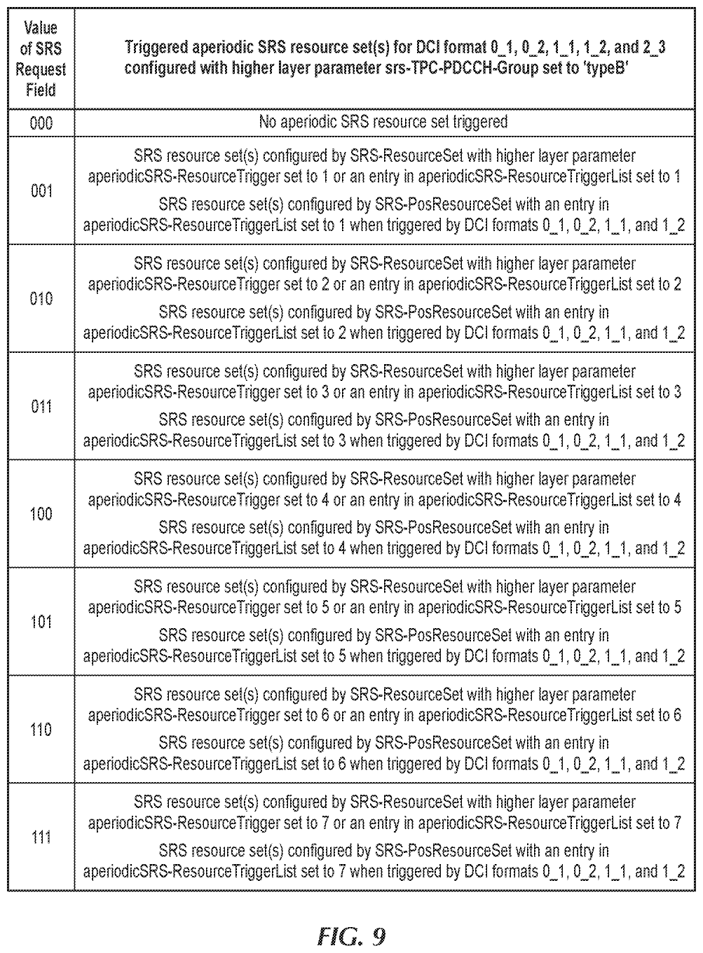

In one or more embodiments, the number of DCI codepoints for A-SRS trigger states may be extended. Currently, the number of DCI codepoints available for trigger states for A-SRS is just 3. In order to support more than 3 trigger states, Table 7.3.1.1.2-24 of the specification(s) in [5] may be appropriately updated to capture more code points as shown in FIG. 9. In particular, as shown in FIG. 9, in order to have 7 trigger states for A-SRS and assuming a bitwidth of 3-bits for an SRS request field then Table 7.3.1.1.2-24 in [5] can be updated as shown. For example, new entries may be defined for 100, 101, 110, and 111.

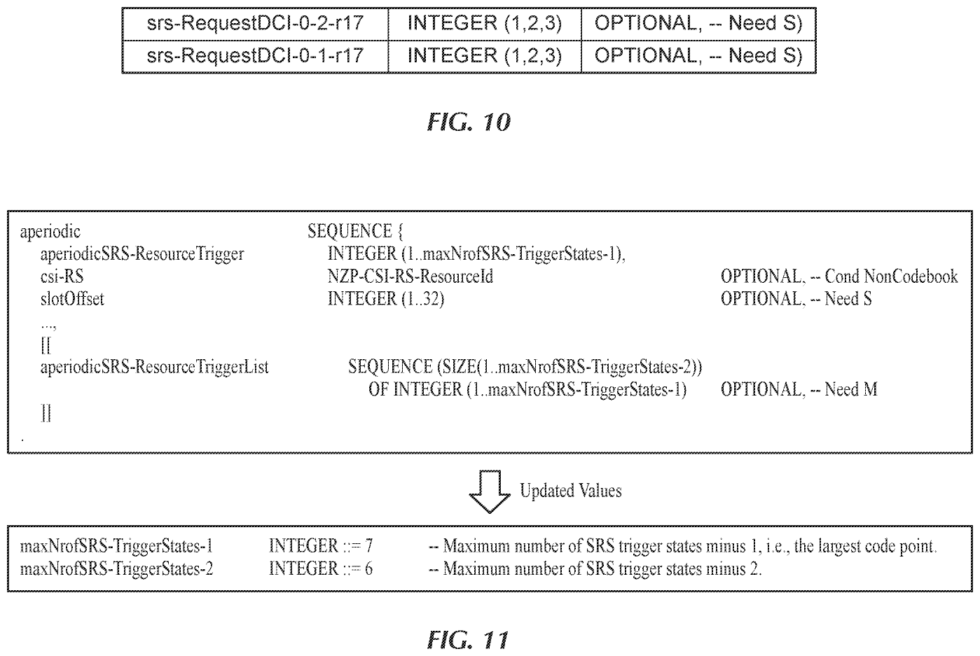

Additionally, in order to provide flexibility in controlling the DCI overhead, it is possible to configure the size of ‘SRS request’ field using RRC signaling. Subsequently, based on the size of configured ‘SRS request’ field, certain rows from Table 7.3.1.1.2-24 in [5] can be selected as shown in FIG. 9. For example, when it is possible to have 7 trigger states for A-SRS (as shown in FIG. 9), the size of SRS request field can be higher-layer configured. In particular, one example of a higher-layer configuration for the size of the SRS field is shown in FIG. 10.

srs-RequestDCI-0-2 is defined as follows:

Indicate the number of bits for “SRS request” in DCI format 0_2. When the field is absent, then the value of 0 bit for “SRS request” in DCI format 0_2 is applied. If the parameter srs-RequestDCI-0-2 is configured to value 1, 1 bit is used to indicate one of the first two rows of Table 7.3.1.1.2-24 in TS 38.212 for triggered aperiodic SRS resource set. If the value 2 is configured, 2 bits are used to indicate one of the first four rows of Table 7.3.1.1.2-24 in TS 38.212. If the value 3 is configured, 3 bits are used to indicate one of the rows of Table 7.3.1.1.2-24 in TS 38.212. When the UE is configured with supplementaryUplink, an extra bit (i.e., the first bit of the SRS request field) is used for the non-SUL/SUL indication.

It is noted that in Rel.16, the above higher-layer parameter is introduced to control the DCI payload of DCI format 0_2 (i.e., called compact DCI, compared to Rel.15 DCI format 0_1). The above proposal can be also applied to DCI format 0_1. The straight forward way is to define a different higher layer parameter (i.e., as above) to control the size of SRS request field for DCI format 0_1 and 0_2 separately. Another way is to only define a higher-layer parameter (i.e., as above) to control the size of SRS request field for 0_2, and the DCI size of the SRS request field for 0_1 is derived by an implicit rule (e.g., the number of SRS resource sets with usage CB/NCB).

Further, in order to support newly added A-SRS trigger states, RRC parameters maxNrofSRS-TriggerStates-1 and maxNrofSRS-TriggerStates-2 are updated in aperiodicSRS-ResourceTrigger and aperiodicSRS-ResourceTriggerList of [6], respectively, as shown in FIG. 11. For example, when it is possible to have 7 trigger states for A-SRS, maxNrofSRS-TriggerStates-1 and maxNrofSRS-TriggerStates-2 need to be updated as shown by the updated values in FIG. 11.

As another option, depending on whether DCI schedules data/CSI, the UE may select the appropriate table for A-SRS trigger states. That is, for DCI without scheduling data/CSI, the SRS request field size is 1, 2 or 3 bits. The higher layer can configure which entries to consider from the A-SRS trigger state table, i.e., Table 7.3.1.1.2-24 [5], for DCI without data/CSI as shown in FIG. 9. Following this example, FIG. 10 shows new RRC parameters that may be applicable only for DCI without scheduling data/CSI. As mentioned above, the table for capturing A-SRS trigger states in this scenario is shown in FIG. 9.

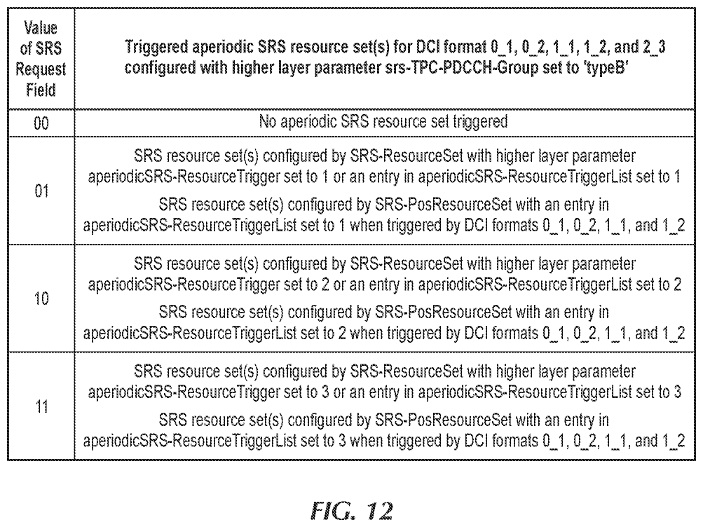

For DCI scheduling with data/CSI, the SRS request field size is 1 or 2 bits. Thus, the table shown in FIG. 12 may be considered in the scenario where DCI scheduling includes data/CSI.

### Variations

The information, signals, and/or others described in this specification may be represented by using any of a variety of different technologies. For example, data, instructions, commands, information, signals, bits, symbols, chips, and so on, all of which may be referenced throughout the herein-contained description, may be represented by voltages, currents, electromagnetic waves, magnetic fields or particles, optical fields or photons, or any combination of these.

Also, information, signals, and so on can be output from higher layers to lower layers and/or from lower layers to higher layers. Information, signals, and so on may be input and/or output via a plurality of network nodes.

The information, signals, and so on that are input and/or output may be stored in a specific location (for example, a memory) or may be managed by using a management table. The information, signals, and so on to be input and/or output can be overwritten, updated, or appended. The information, signals, and so on that are output may be deleted. The information, signals, and so on that are input may be transmitted to another apparatus.

Reporting of information is by no means limited to the aspects/present embodiments described in this specification, and other methods may be used as well. For example, reporting of information may be implemented by using physical layer signaling (for example, downlink control information (DCI), uplink control information (UCI), higher layer signaling (for example, RRC (Radio Resource Control) signaling, broadcast information (master information block (MIB), system information blocks (SIBs), and so on), MAC (Medium Access Control) signaling and so on), and other signals and/or combinations of these.

Software, whether referred to as “software,” “firmware,” “middleware,” “microcode,” or “hardware description language,” or called by other terms, should be interpreted broadly to mean instructions, instruction sets, code, code segments, program codes, programs, subprograms, software modules, applications, software applications, software packages, routines, subroutines, objects, executable files, execution threads, procedures, functions, and so on.

Also, software, commands, information, and so on may be transmitted and received via communication media. For example, when software is transmitted from a website, a server, or other remote sources by using wired technologies (coaxial cables, optical fiber cables, twisted-pair cables, digital subscriber lines (DSL), and so on) and/or wireless technologies (infrared radiation, microwaves, and so on), these wired technologies and/or wireless technologies are also included in the definition of communication media.

The terms “system” and “network” as used in this specification are used interchangeably.

In the present specification, the terms “base station (BS),” “radio base station,” “eNB,” “gNB,” “cell,” “sector,” “cell group,” “carrier,” and “component carrier” may be used interchangeably. A base station may be referred to as a “fixed station,” “NodeB,” “eNodeB (eNB),” “access point,” “transmission point,” “receiving point,” “femto cell,” “small cell” and so on.

A base station can accommodate one or a plurality of (for example, three) cells (also referred to as “sectors”). When a base station accommodates a plurality of cells, the entire coverage area of the base station can be partitioned into multiple smaller areas, and each smaller area can provide communication services through base station subsystems (for example, indoor small base stations (RRHs (Remote Radio Heads))). The term “cell” or “sector” refers to part of or the entire coverage area of a base station and/or a base station subsystem that provides communication services within this coverage.

In the present specification, the terms “mobile station (MS),” “user terminal,” “user equipment (UE),” and “terminal” may be used interchangeably.

A mobile station may be referred to as, by a person skilled in the art, a “subscriber station,” “mobile unit,” “subscriber unit,” “wireless unit,” “remote unit,” “mobile device,” “wireless device,” “wireless communication device,” “remote device,” “mobile subscriber station,” “access terminal,” “mobile terminal,” “wireless terminal,” “remote terminal,” “handset,” “user agent,” “mobile client,” “client,” or some other appropriate terms in some cases.

Furthermore, the radio base stations in this specification may be interpreted as user terminals. For example, each aspect/present embodiment of the present disclosure may be applied to a configuration in which communication between a radio base station and a user terminal is replaced with communication among a plurality of user terminals (D2D (Device-to-Device)). In this case, the user terminals 20 may have the functions of the radio base stations 10 described above. In addition, wording such as “uplink” and “downlink” may be interpreted as “side.” For example, an uplink channel may be interpreted as a side channel.

Likewise, the user terminals in this specification may be interpreted as radio base stations. In this case, the radio base stations may have the functions of the user terminals described above.

Actions which have been described in this specification to be performed by a base station may, in some cases, be performed by upper nodes. In a network including one or a plurality of network nodes with base stations, it is clear that various operations that are performed to communicate with terminals can be performed by base stations, one or more network nodes (for example, MMEs (Mobility Management Entities), S-GW (Serving-Gateways), and so on may be possible, but these are not limiting) other than base stations, or combinations of these.

One or more embodiments illustrated in this specification may be used individually or in combinations, which may be switched depending on the mode of implementation. The order of processes, sequences, flowcharts, and so on that have been used to describe the aspects/present embodiments herein may be re-ordered as long as inconsistencies do not arise. For example, although various methods have been illustrated in this specification with various components of steps in exemplary orders, the specific orders that are illustrated herein are by no means limiting.

One or more embodiments illustrated in the present disclosure may be applied to LTE (Long Term Evolution), LTE-A (LTE-Advanced), LTE-B (LTE-Beyond), SUPER 3G, IMT-Advanced, 4G (4th generation mobile communication system), 5G (5th generation mobile communication system), FRA (Future Radio Access), New-RAT (Radio Access Technology), NR(New Radio), NX (New radio access), FX (Future generation radio access), GSM (registered trademark) (Global System for Mobile communications), CDMA 2000, UMB (Ultra Mobile Broadband), IEEE 802.11 (Wi-Fi (registered trademark)), IEEE 802.16 (WiMAX (registered trademark)), IEEE 802.20, UWB (Ultra-WideBand), Bluetooth (registered trademark), systems that use other adequate radio communication methods and/or next-generation systems that are enhanced based on these.

The phrase “based on” (or “on the basis of”) as used in this specification does not mean “based only on” (or “only on the basis of”), unless otherwise specified. In other words, the phrase “based on” (or “on the basis of”) means both “based only on” and “based at least on” (“only on the basis of” and “at least on the basis of”).

Reference to elements with designations such as “first,” “second” and so on as used herein does not generally limit the quantity or order of these elements. These designations may be used herein only for convenience, as a method for distinguishing between two or more elements. Thus, reference to the first and second elements does not imply that only two elements may be employed, or that the first element must precede the second element in some way.

The term “judging (determining)” as used herein may encompass a wide variety of actions. For example, “judging (determining)” may be interpreted to mean making “judgments (determinations)” about calculating, computing, processing, deriving, investigating, looking up (for example, searching a table, a database, or some other data structures), ascertaining, and so on. Furthermore, “judging (determining)” may be interpreted to mean making “judgments (determinations)” about receiving (for example, receiving information), transmitting (for example, transmitting information), input, output, accessing (for example, accessing data in a memory), and so on. In addition, “judging (determining)” as used herein may be interpreted to mean making “judgments (determinations)” about resolving, selecting, choosing, assuming, establishing, comparing, and so on. In other words, “judging (determining)” may be interpreted to mean making “judgments (determinations)” about some action.

The terms “connected” and “coupled,” or any variation of these terms as used herein mean all direct or indirect connections or coupling between two or more elements, and may include the presence of one or more intermediate elements between two elements that are “connected” or “coupled” to each other. The coupling or connection between the elements may be physical, logical, or a combination thereof. For example, “connection” may be interpreted as “access.”

In this specification, when two elements are connected, the two elements may be considered “connected” or “coupled” to each other by using one or more electrical wires, cables and/or printed electrical connections, and, as some non-limiting and non-inclusive examples, by using electromagnetic energy having wavelengths in radio frequency regions, microwave regions, (both visible and invisible) optical regions, or the like.

In this specification, the phrase “A and B are different” may mean that “A and B are different from each other.” The terms “separate,” “be coupled” and so on may be interpreted similarly.

Furthermore, the term “or” as used in this specification or in claims is intended to be not an exclusive disjunction.

Now, although the present invention has been described in detail above, it should be obvious to a person skilled in the art that the present invention is by no means limited to the embodiments described in this specification. The present invention can be implemented with various corrections and in various modifications, without departing from the spirit and scope of the invention defined by the recitations of claims. Consequently, the description in this specification is provided only for the purpose of explaining examples, and should by no means be construed to limit the invention according to the present invention in any way.

### Alternative Examples

The above examples and modified examples may be combined with each other, and various features of these examples may be combined with each other in various combinations. The invention is not limited to the specific combinations disclosed herein.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A wireless communication method for a terminal comprising:
receiving, via downlink control information (DCI) or higher layer signaling, configuration information including a parameter;
configuring Aperiodic Sounding Reference Signal (A-SRS) transmission based on the parameter; and
reporting, based on a usage setting, capability information including a minimum timing requirement between A-SRS triggering Physical Downlink Control Channel (PDCCH) and SRS resources in a resource set.

2. The wireless communication method of claim 1, wherein the reported timing requirement is used to determine a minimal time interval between a last symbol of the PDCCH triggering and a first symbol of the SRS resources.

3. The wireless communication method of claim 1, wherein the usage is configured with a first setting, and the minimum timing requirement is a sum of a first number of symbols and an additional time duration.

4. The wireless communication method of claim 3, wherein the usage is configured with a second setting, and the minimum timing requirement is a sum of a second number of symbols and the additional time duration.

5. The wireless communication method of claim 4, wherein the second number of symbols is greater than the first number of symbols.

6. The wireless communication method of claim 1, wherein the minimum timing requirement is defined irrespective of the usage setting.

7. The wireless communication method of claim 1, further comprising:
assuming a first DCI size of a first DCI format of the DCI and a first aggregation level of the PDCCH; and
demodulating the PDCCH based on the first DCI size and the first aggregation level.

8. The wireless communication method of claim 7, further comprising:
performing a Cyclic Redundancy Check (CRC) on the demodulated PDCCH,
wherein the CRC is scrambled by a Radio Network Temporary Identifier (RNTI).

9. The wireless communication method of claim 8, further comprising:
determining that the CRC passed and identifying that the DCI is successfully received.

10. The wireless communication method of claim 8, further comprising:
determining that the CRC failed;
assuming a second DCI size of the first DCI format and a second aggregation level of the PDCCH; and
demodulating the PDCCH based on the second DCI size and the second aggregation level.

11. The wireless communication method of claim 8, wherein the first DCI size and the first aggregation level are signaled by the parameter.

12. The wireless communication method of claim 11, wherein the parameter is configured with higher layer signaling.

13. The wireless communication method of claim 8, wherein the parameter is predefined.

14. The wireless communication method of claim 1, further comprising:
selecting a table for A-SRS trigger based on the DCI.

15. A terminal comprising:
a receiver that receives, via downlink control information (DCI) or higher layer signaling, configuration information including a parameter; and
a processor that configures Aperiodic Sounding Reference Signal (A-SRS) transmission based on the parameter; and reports, based on a usage setting, capability information including a minimum timing requirement between A-SRS triggering Physical Downlink Control Channel (PDCCH) and SRS resources in a resource set.

16. A system comprising:
a terminal comprising:
a first receiver that receives via downlink control information (DCI) or higher layer signaling, configuration information including a parameter;
a processor that configures Aperiodic Sounding Reference Signal (A-SRS) transmission based on the parameter; and reports, based on a usage setting, capability information including a minimum timing requirement between A-SRS triggering Physical Downlink Control Channel (PDCCH) and SRS resources in a resource set; and
a base station comprising:
a transmitter that transmits via DCI or higher layer signaling, configuration information including the parameter; and
a second receiver that receives the capability information.
